(19) United States
(12) Patent Application Publication
(10) Pub. No.: US 2026/0161157 A1
(43) Pub. Date: Jun. 11, 2026

(54) INFORMATION PROCESSING APPARATUS, MACHINE DIFFERENCE ANALYSIS METHOD, AND SUBSTRATE PROCESSING APPARATUS

(71) Applicant: Tokyo Electron Limited, Tokyo (JP)

(72) Inventor: Huizhen BU, Tokyo (JP)

(21) Appl. No.: 19/180,271

(22) Filed: Apr. 16, 2025

(30) Foreign Application Priority Data
Apr. 24, 2024 (JP) 2024-070720

(51) Int. Cl. G05B 23/02

(52) U.S. Cl. CPC G05B 23/0221

(57) ABSTRACT

An information processing apparatus includes: a reconstruction error matrix generation unit that verifies reconstruction errors of datasets of a plurality of substrate processing apparatuses using a dimensionality reduction model trained with a reference dataset and generates reconstruction error matrices for the plurality of substrate processing apparatuses; a machine difference calculation unit that calculates a machine difference based on magnitudes of at least a portion of the reconstruction errors selected from the reconstruction errors included in the reconstruction error matrices; and a display control unit that causes the calculated machine difference to be displayed on a display device.

### CROSS-REFERENCE TO RELATED APPLICATIONS

This application is based on and claims priority from Japanese Patent Application No. 2024-070720, filed on Apr. 24, 2024, with the Japan Patent Office, the disclosure of which is incorporated herein in its entirety by reference.

### TECHNICAL FIELD

The present disclosure relates to an information processing apparatus, a machine difference analysis method, and a substrate processing apparatus.

### BACKGROUND

In a semiconductor manufacturing apparatus executing a process according to the same recipe, for example, the sensor behavior (sensor waveform data) becomes theoretically identical. Therefore, a technique is known in which a machine difference analysis function is implemented using the sensor log data of semiconductor manufacturing apparatuses that execute a process according to the same recipe (see, e.g., Japanese Patent Application Laid-Open Publication No. 2022-003664).

### SUMMARY

An aspect of the present disclosure is an information processing apparatus that performs machine difference analysis on a plurality of substrate processing apparatuses. The information processing apparatus includes: a reconstruction error matrix generation unit that verifies reconstruction errors of datasets of the plurality of substrate processing apparatuses using a dimensionality reduction model trained with a reference dataset and generates reconstruction error matrices for the plurality of substrate processing apparatuses; a machine difference calculation unit that calculates a machine difference based on magnitudes of at least some of the reconstruction errors selected from the reconstruction errors included in the reconstruction error matrices; and a display control unit that causes the calculated machine difference to be displayed on a display device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram illustrating a substrate processing system according to an embodiment.

FIG. 2 is a hardware configuration diagram illustrating an example of a computer.

FIG. 3 is a functional block diagram illustrating an example of an apparatus controller according to the embodiment.

FIG. 4 is an explanatory diagram illustrating an example of processing of a training unit and a reconstruction error matrix generation unit.

FIG. 5 is an explanatory diagram illustrating an example of processing in a verification phase.

FIG. 6 is a configuration diagram illustrating an example of a reconstruction error matrix.

FIG. 7 is an explanatory diagram illustrating an example of the reconstruction error matrix in which a reconstruction error range has been selected.

FIG. 8 is a diagram illustrating an example of machine difference calculations for each hierarchical level.

FIG. 9 is a flowchart illustrating an example of processing of a machine difference analysis method performed by the substrate processing system according to the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made without departing from the spirit or scope of the subject matter presented here.

Hereinafter, embodiments of the present disclosure will be described with reference to the drawings.

### System Configuration

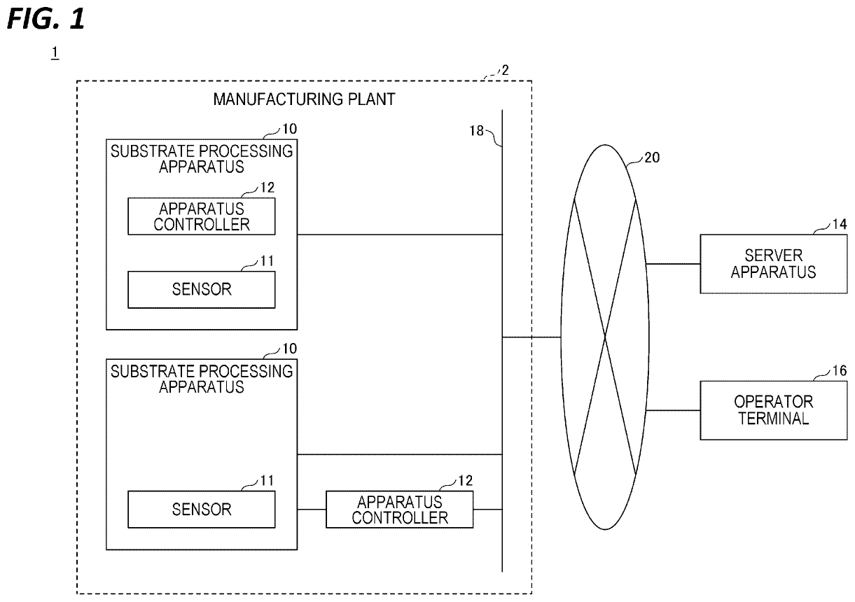

FIG. 1 is a configuration diagram illustrating an example of a substrate processing system 1 according to the present embodiment. The substrate processing system 1 illustrated in FIG. 1 includes a substrate processing apparatus 10, a sensor 11, an apparatus controller 12, a server apparatus 14, and an operator terminal 16. The substrate processing apparatus 10, the sensor 11, and the apparatus controller 12 are installed in a manufacturing plant 2. The server apparatus 14 and the operator terminal 16 may be installed in the manufacturing plant 2 or outside the manufacturing plant 2. The operator terminal 16 is an information processing terminal such as a personal computer (PC) or a smartphone, operated by an operator such as the person in charge of the substrate processing apparatus 10 installed in the manufacturing plant 2.

The substrate processing apparatus 10, the apparatus controller 12, the server apparatus 14, and the operator terminal 16 illustrated in FIG. 1 are communicably connected via networks 18 and 20 such as the Internet or a local area network (LAN).

The substrate processing apparatus 10 is an apparatus that performs processing such as film formation, etching, or ashing and processes, for example, a semiconductor wafer (hereinafter, simply referred to as a “wafer”). The substrate processing apparatus 10 may be, for example, a semiconductor manufacturing apparatus, a heat treatment apparatus, or a film formation apparatus. The substrate processing apparatus 10 receives, for example, a recipe from the apparatus controller 12 and executes the recipe to perform a process (processing). The recipe is a control command combining setting values for various categories such as temperature, gas, pressure, plasma, and mechanism. The recipe of the substrate processing apparatus 10 has a plurality of control units called steps. The process of the substrate processing apparatus 10 includes a plurality of steps.

The substrate processing apparatus 10 is equipped with a plurality of sensors 11, such as a temperature sensor for measuring temperature and a pressure sensor for measuring pressure. The substrate processing apparatus 10 is also equipped with an actuator that performs mechanical operations by combining a power source and structural components.

The apparatus controller 12 has a man-machine interface function that not only receives instructions from an operator regarding the substrate processing apparatus 10 but also provides the operator with information related to the substrate processing apparatus 10. The apparatus controller 12 receives sensor data output from the plurality of sensors 11 installed in the substrate processing apparatus 10. The apparatus controller 12 may perform, for example, abnormality detection or abnormality prediction for the substrate processing apparatus 10.

The apparatus controller 12 illustrated in FIG. 1 is provided for each substrate processing apparatus 10, but may be provided for a plurality of substrate processing apparatuses 10. The apparatus controller 12 may be installed inside or outside the housing of the substrate processing apparatus 10. In addition, the apparatus controller 12 may have a function for communicating with an apparatus controller 12 for another substrate processing apparatus 10. The apparatus controller 12 may also have a function for communicating with an apparatus controller 12 for another substrate processing apparatus 10 via the server apparatus 14. In this manner, the apparatus controller 12 may utilize information related to a plurality of substrate processing apparatuses 10 (e.g., sensor waveform data for each step when a process is executed according to the same recipe).

The server apparatus 14 may receive sensor data output from the plurality of sensors 11 installed in the substrate processing apparatus 10 and store the data as a process log for each process execution (each run).

The server apparatus 14 may store, for each run, information related to a plurality of substrate processing apparatuses 10 in one or more manufacturing plants 2 (e.g., the recipe of a process performed by the substrate processing apparatus 10, sensor data obtained when the process is executed using the recipe, and result data) as a process log.

The apparatus controller 12 and the server apparatus 14 may display information related to the substrate processing apparatus 10 on the operator terminal 16 or notify the operator of the operator terminal 16 via, for example, electronic mail. In addition, at least one of the apparatus controller 12, the server apparatus 14, and the operator terminal 16 has a function of editing the recipe to be executed by the substrate processing apparatus 10. The apparatus controller 12, the server apparatus 14, and the operator terminal 16 illustrated in FIG. 1 are examples of an information processing apparatus according to the present embodiment.

The substrate processing system 1 illustrated in FIG. 1 is an example, and various system configurations are of course possible depending on the application and purpose. The classification of apparatuses such as the apparatus controller 12 and the server apparatus 14 in FIG. 1 is an example. For example, various configurations are possible, including an integrated configuration of the apparatus controller 12 and the server apparatus 14 or a further subdivided configuration.

### Hardware Configuration

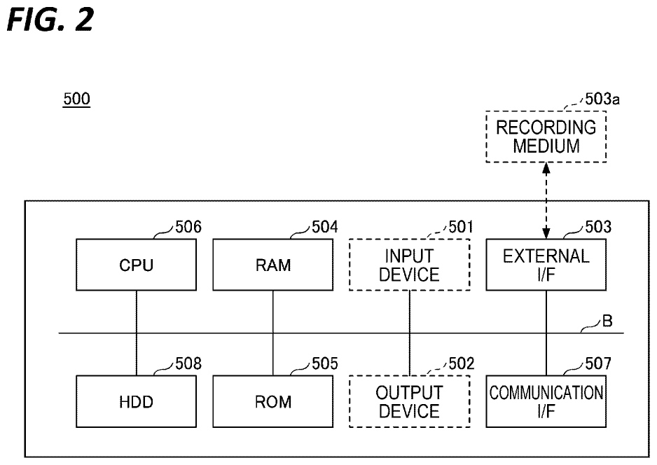

The apparatus controller 12, the server apparatus 14, and the operator terminal 16 illustrated in FIG. 1 may be implemented using a computer having the hardware configuration illustrated in FIG. 2. FIG. 2 is a hardware configuration diagram illustrating an example of a computer 500.

The computer 500 illustrated in FIG. 2 includes an input device 501, an output device 502, an external interface (I/F) 503, random access memory (RAM) 504, read-only memory (ROM) 505, a central processing unit (CPU) 506, a communication interface (I/F) 507, and a hard disk drive (HDD) 508, all of which are connected to each other via a bus B. The input device 501 and the output device 502 may be connected and used as needed.

The input device 501 includes a keyboard, a mouse, or a touch panel and is used by an operator to input operational signals. The output device 502 is a display or the like and displays a processing result from the computer 500. The communication I/F 507 is an interface that connects the computer 500 to the networks 18 and 20 illustrated in FIG. 1. The HDD 508 is an example of a non-volatile storage device that stores programs and data.

The external I/F 503 serves as an interface with external devices. The computer 500 may read a recording medium 503a, such as a secure digital (SD) memory card, via the external I/F 503. The external I/F 503 may be capable of writing to a recording medium 503 a, such as an SD memory card, via the external I/F 503.

The ROM 505 is an example of a non-volatile semiconductor memory (storage device) that stores programs and data. The RAM 504 is an example of a volatile semiconductor memory (storage device) that temporarily holds programs and data. The CPU 506 is a calculation device that executes programs and data read from a storage device such as the ROM 505 or the HDD 508 onto the RAM 504, thereby controlling the overall operation and functions of the computer 500.

The apparatus controller 12, the server apparatus 14, and the operator terminal 16 of the substrate processing system 1 illustrated in FIG. 1 implement various functions described later by executing programs on the computer 500 illustrated in FIG. 2.

### Functional Configuration

Hereinbelow, an example in which the apparatus controller 12 serves as an information processing apparatus that performs machine difference analysis on a plurality of substrate processing apparatuses 10 is described. The information processing apparatus that performs machine difference analysis on a plurality of substrate processing apparatuses 10 may also be the server apparatus 14 or the operator terminal 16.

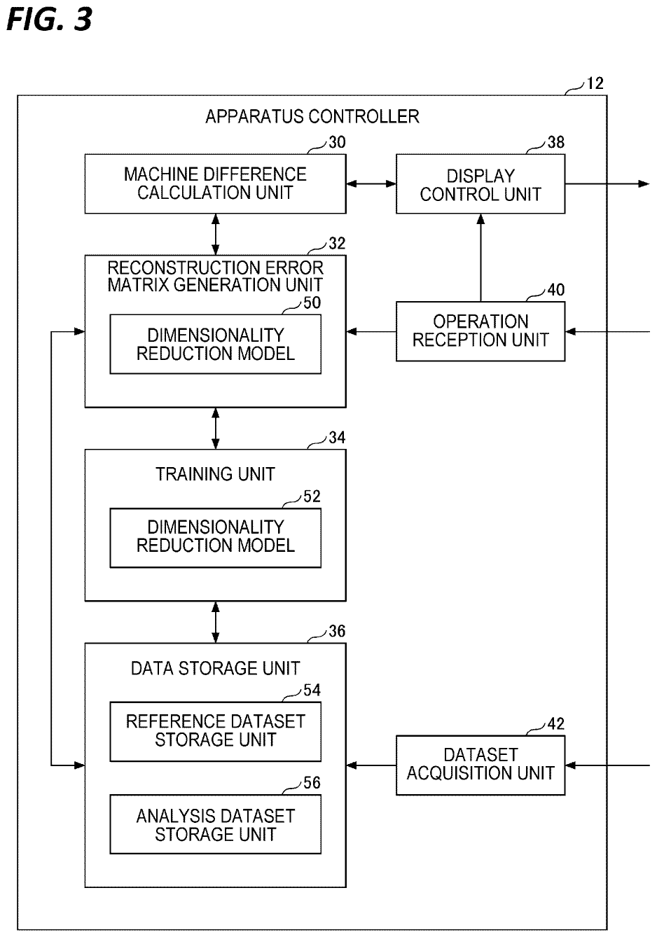

The apparatus controller 12 of the substrate processing system 1 according to the present embodiment is implemented using, for example, the functional blocks illustrated in FIG. 3. FIG. 3 is a functional block diagram illustrating an example of the apparatus controller 12 according to the present embodiment. The functional block diagram in FIG. 3 omits configurations that are not necessary for describing the present embodiment.

The apparatus controller 12 executes a program for the apparatus controller 12 to implement a machine difference calculation unit 30, a reconstruction error matrix generation unit 32, a training unit 34, a data storage unit 36, a display control unit 38, an operation reception unit 40, and a dataset acquisition unit 42. The reconstruction error matrix generation unit 32 includes a dimensionality reduction model 50. The training unit 34 includes a dimensionality reduction model 52. The data storage unit 36 includes a reference dataset storage unit 54 and an analysis dataset storage unit 56.

The dataset acquisition unit 42 acquires and stores a reference dataset in the reference dataset storage unit 54. The reference dataset includes sensor data output from the sensor 11 while the reference substrate processing apparatus 10 executes a process according to a recipe. The reference substrate processing apparatus 10 is, for example, a golden apparatus, which is a reference apparatus guaranteed to operate perfectly.

The dataset acquisition unit 42 also acquires an analysis dataset and stores it in the analysis dataset storage unit 56. The analysis dataset includes sensor data output from the sensor 11 while the substrate processing apparatus 10, which is subject to machine difference analysis, executes a process according to a recipe. The data storage unit 36 includes the reference dataset storage unit 54, which stores the reference dataset, and the analysis dataset storage unit 56, which stores the analysis dataset.

The training unit 34 trains the dimensionality reduction model 52 with the reference dataset stored in the reference dataset storage unit 54. The dimensionality reduction model 52 projects data in a high-dimensional space onto data in a low-dimensional space.

The dimensionality reduction model 52 is principal component analysis (PCA), Gaussian process latent variable model (GPLVM), mixture probabilistic principal component analysis (MPPCA), kernel PCA, or probabilistic PCA.

The reconstruction error matrix generation unit 32 verifies the reconstruction error of the analysis dataset stored in the analysis dataset storage unit 56 using the dimensionality reduction model 50 trained by the training unit 34. The reconstruction error refers to the difference between the original data and reconstructed data when the original data is reduced in dimensionality from a high-dimensional space to a low-dimensional space and then reconstructed from the low-dimensional space to the high-dimensional space. In addition, the reconstruction error matrix generation unit 32 verifies the reconstruction error and generates a reconstruction error matrix, which will be described later.

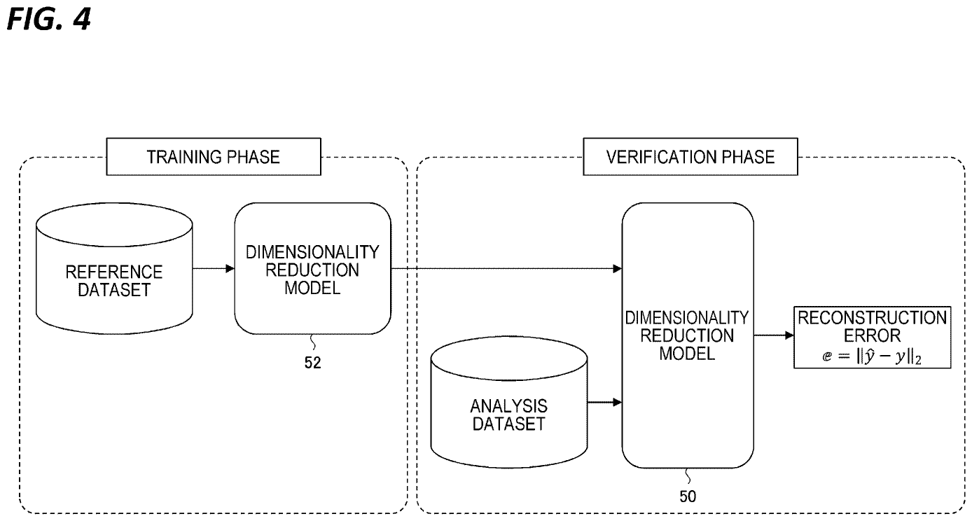

The processing of the training unit 34 and the reconstruction error matrix generation unit 32 is described with reference to FIG. 4. FIG. 4 is an explanatory diagram illustrating an example of the processing of the training unit 34 and the reconstruction error matrix generation unit 32.

In the training phase, the training unit 34 trains the dimensionality reduction model 52 using the reference dataset stored in the reference dataset storage unit 54. The training unit 34 trains the dimensionality reduction model 52, for example, unsupervised learning.

In the verification phase, the reconstruction error matrix generation unit 32 verifies the reconstruction error of the analysis dataset, which is stored in the analysis dataset storage unit 56, using the dimensionality reduction model 50 trained by the training unit 34.

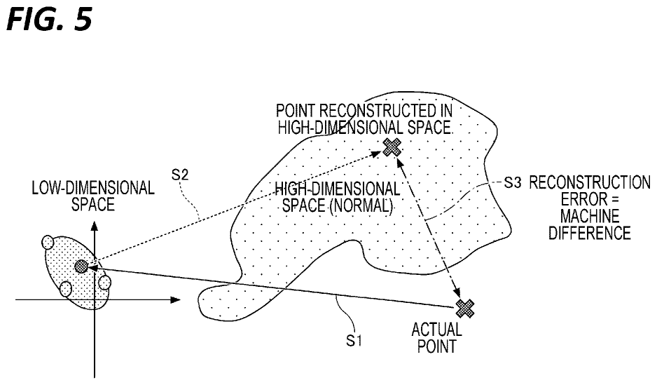

The processing in the verification phase is further described with reference to FIG. 5. FIG. 5 is an explanatory diagram illustrating an example of the processing in the verification phase.

In step S1, the reconstruction error matrix generation unit 32 reduces the dimensionality of the original data (the actual point in FIG. 5) of the analysis dataset from a high-dimensional space to a low-dimensional space using the dimensionality reduction model 50 trained by the training unit 34.

In step S2, the reconstruction error matrix generation unit 32 reconstructs the data, which was reduced in dimensionality in step S1, back into the high-dimensional space using the dimensionality reduction model 50 trained by the training unit 34.

The position of the data reconstructed into the high-dimensional space is reconstructed into the original high-dimensional space using the dimensionality reduction model 50 trained with the reference dataset, and thus corresponds to the position where the data of the reference substrate processing apparatus 10 should be. Accordingly, the distance between the position of the original data in the high-dimensional space and the position of the reconstructed data obtained by reconstructing the data reduced in dimensionality in step S1 represents the machine difference between the reference substrate processing apparatus 10 and the substrate processing apparatus 10 of the analysis dataset.

In step S3, the reconstruction error matrix generation unit 32 verifies the reconstruction error between the reconstructed data point from the low-dimensional space to the high-dimensional space and the original data of the analysis dataset (the actual point in FIG. 5). Low-frequency data has a larger reconstruction error because an appropriate transformation into the low-dimensional space has not been learned. In addition, the dimensionality reduction model 50 trained by the training unit 34 has been trained with a reference dataset in which setting values vary. For example, even when executing the same recipe, the setting values of the substrate processing apparatus 10 may be adjusted.

Accordingly, the dimensionality reduction model 50 trained by the training unit 34 is able to verify reconstruction errors other than those caused by changes in setting values, even for an analysis dataset in which the setting values have changed. In this manner, the reconstruction error verified in the verification phase represents the machine difference, which accounts for the fluctuation in the data due to changes in setting values.

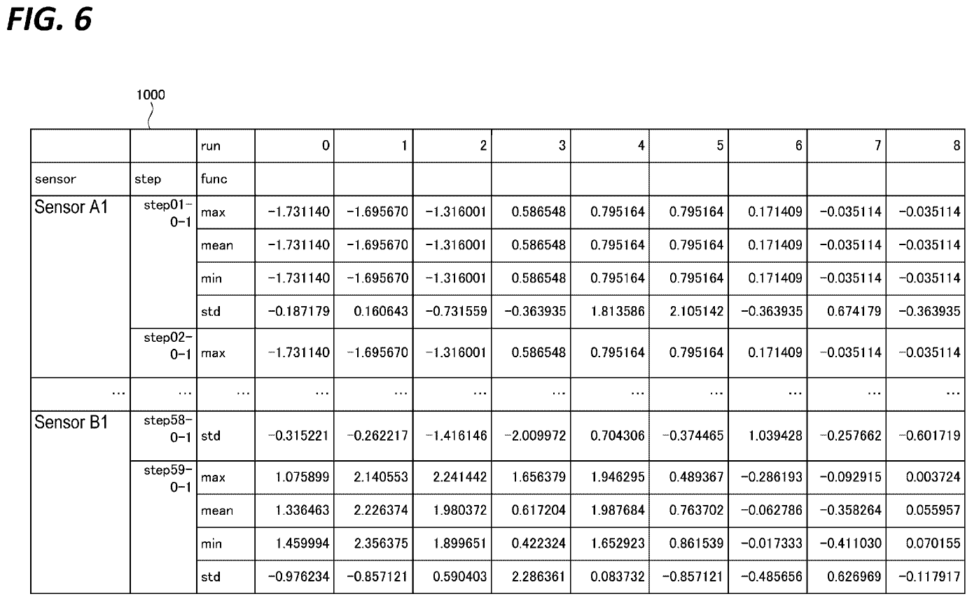

By repeating the processing of the verification phase illustrated in FIG. 5, the reconstruction error matrix generation unit 32 creates, for example, a reconstruction error matrix 1000 illustrated in FIG. 6. FIG. 6 is a configuration diagram illustrating an example of the reconstruction error matrix 1000.

The reconstruction error matrix 1000 illustrated in FIG. 6 represents the reconstruction error for each step of the sensor 11, which detects the state of the substrate processing apparatus 10, as the smallest unit reconstruction error. The horizontal axis of the reconstruction error matrix 1000 represents process executions (runs). The vertical axis of the reconstruction error matrix 1000 represents steps of the sensor 11, the sensor 11 itself, and groups of the sensor 11. The reconstruction error matrix 1000 is created for each substrate processing apparatus 10.

Returning to FIG. 3, the machine difference calculation unit 30 calculates the machine difference based on at least a part of the reconstruction error magnitudes selected from the reconstruction error matrix 1000, which is created by the reconstruction error matrix generation unit 32.

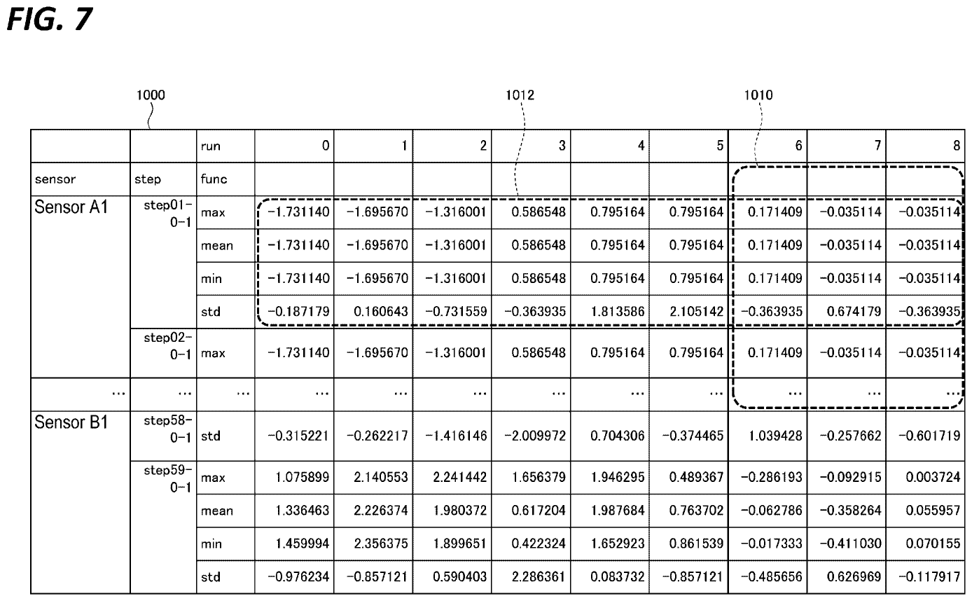

The machine difference calculation unit 30 performs the machine difference calculation for each hierarchical level according to the selected smallest unit reconstruction error range from a plurality of smallest unit reconstruction errors contained in the reconstruction error matrix 1000. FIG. 7 is an explanatory diagram illustrating an example of the reconstruction error matrix 1000 in which a reconstruction error range has been selected.

The reconstruction error range 1010 in FIG. 7 is the smallest unit reconstruction error range selected when calculating the machine difference for runs “6-8” in all steps of the group of sensors to which “Sensor A1” belongs. When the reconstruction error range 1010 in FIG. 7 is selected, the machine difference calculation unit 30 calculates the L2 norm as the magnitude of the smallest unit reconstruction error contained in the range 1010, thereby calculating the machine difference for runs “6-8” in all steps of the group of sensors 11 to which “Sensor A1” belongs.

The reconstruction error range 1012 in FIG. 7 is the smallest unit reconstruction error range selected when calculating the machine difference for all runs in step “1” of “Sensor A1.” When the reconstruction error range 1012 in FIG. 7 is selected, the machine difference calculation unit 30 calculates the L2 norm as the magnitude of the smallest unit reconstruction error contained in the range 1012, thereby calculating the machine difference for all runs in step “1” of “Sensor A1.”

When the number of sensors 11 belonging to the group or the number of runs in the dataset differs, the machine difference may not be directly compared due to the influence of the total number difference of sensors 11 in the group and the number difference of runs in the dataset. Therefore, in the present embodiment, the machine difference may be adjusted using Equation (1) below, considering the difference in total number of sensors 11 belonging to the group.

$$Adjusted machine difference = L 2 norm / number of sensors 11 in the group \times average number of sensors 11 across all groups \qquad ( 1 )$$

In addition, in the present embodiment, the machine difference may be adjusted considering the number of runs in the dataset using Equation (2) below.

$$Adjusted machine difference = L 2 norm / number of runs in the dataset \times average number of runs across all datasets \qquad ( 2 )$$

Furthermore, according to the reconstruction error matrix 1000 illustrated in FIGS. 6 and 7, since both the number of steps of each sensor 11 and the number of summary types such as “max,” “mean,” “min,” and “std” for each step are identical, comparisons may be made even between different steps or between different sensors 11.

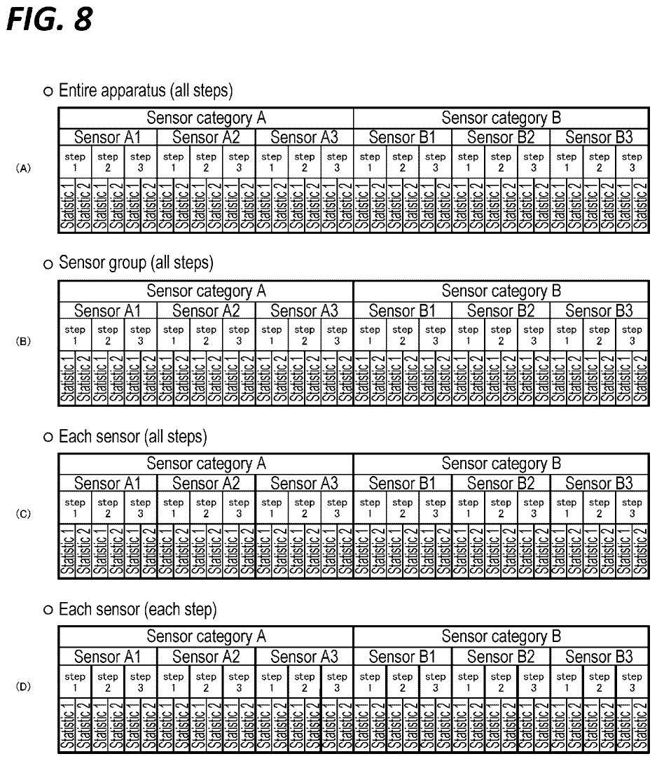

Furthermore, according to the reconstruction error matrix 1000 illustrated in FIGS. 6 and 7, as illustrated in FIG. 8, the reconstruction error for each step of the sensor 11, which detects the state of the substrate processing apparatus 10, is treated as the smallest unit reconstruction error. The magnitudes of the reconstruction errors for each step of the sensor 11, all steps of the sensor 11, all steps of the sensor group, and all steps of the substrate processing apparatus 10 may be calculated as machine differences for each layer.

FIG. 8 is a diagram illustrating an example of machine difference calculations for each hierarchical level. (A) of FIG. 8 illustrates the smallest unit reconstruction error range selected when calculating the magnitudes of the reconstruction errors for all steps of the substrate processing apparatus 10. (B) of FIG. 8 illustrates the smallest unit reconstruction error range selected when calculating the magnitudes of the reconstruction errors for all steps of the group of the sensors 11.

(C) of FIG. 8 illustrates the smallest unit reconstruction error range selected when calculating the magnitudes of the reconstruction errors for all steps of each sensor 11. (D) of FIG. 8 illustrates the smallest unit reconstruction error range selected when calculating the magnitude of the reconstruction error for each step of each sensor 11.

Returning to FIG. 3, the display control unit 38 causes the output device 502, such as a display device, to display the machine difference calculated by the machine difference calculation unit 30. The operation reception unit 40 receives various operations from the operator. For example, the operation reception unit 40 receives selections from the operator for the reconstruction error range 1010 or 1012 illustrated in FIG. 7.

### Processing

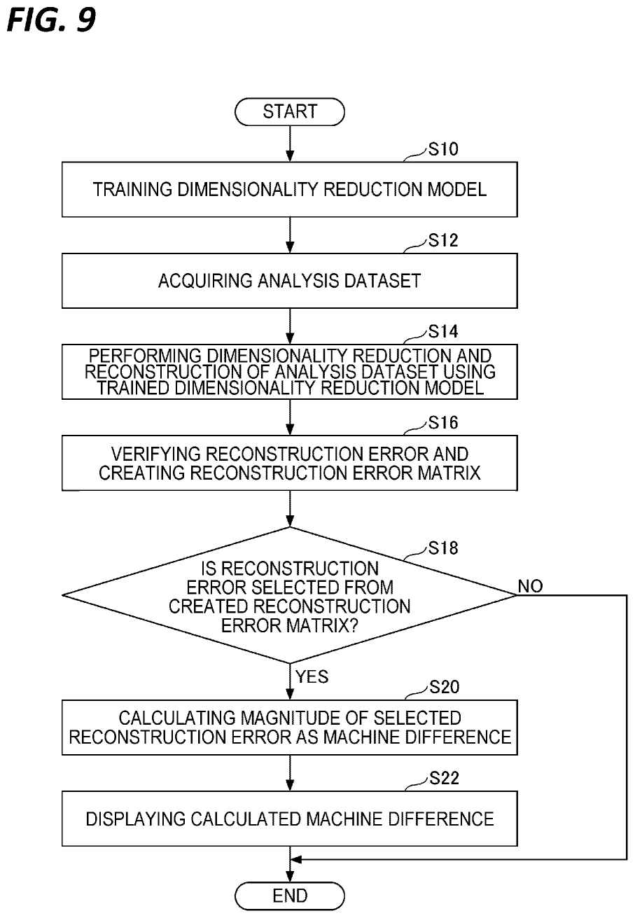

FIG. 9 is a flowchart illustrating an example of the processing of a machine difference analysis method performed by the substrate processing system 1 according to the present embodiment.

In step S10, the training unit 34 of the apparatus controller 12 trains the dimensionality reduction model 52 using the reference dataset stored in the reference dataset storage unit 54. The dimensionality reduction model 52 may use PCA, GPLVM, MPPCA, Kernel PCA, or Probabilistic PCA. However, from the perspective of accuracy, it is preferable to use PCA and GPLVM.

In step S12, the dataset acquisition unit 42 acquires an analysis dataset and stores it in the analysis dataset storage unit 56.

In step S14, the reconstruction error matrix generation unit 32 reduces the dimensionality of the original data of the analysis dataset from a high-dimensional space to a low-dimensional space and reconstructs the data from the low-dimensional space to the high-dimensional space using the dimensionality reduction model 50 trained by the training unit 34.

In step S16, the reconstruction error matrix generation unit 32 verifies the reconstruction error, which is the difference from the original data when reconstructing the data from the low-dimensional space to the high-dimensional space, and generates the reconstruction error matrix 1000 illustrated in FIG. 6.

In step S18, the machine difference calculation unit 30 determines whether the selection of a reconstruction error has been made, for example, as illustrated in the reconstruction error range 1010 or 1012 in FIG. 7, based on the created reconstruction error matrix 1000. When no selection of a reconstruction error is made, the apparatus controller 12 terminates the processing of the flowchart in FIG. 9.

When the selection of a reconstruction error is made, the process proceeds to step S20, where the machine difference calculation unit 30 calculates the machine difference based on the magnitudes of the reconstruction errors of the selected reconstruction error range 1010 or 1012 in FIG. 7 taken from the reconstruction error matrix 1000. For example, the machine difference calculation unit 30 calculates the L2 norm of a plurality of reconstruction errors included in the reconstruction error range 1010 or 1012 as the magnitude of the reconstruction error. Since the machine difference calculation unit 30 only needs to calculate the L2 norm of a plurality of reconstruction errors, the calculation cost is reduced.

In step S22, the display control unit 38 causes the output device 502, such as a display device, to display the machine difference calculated by the machine difference calculation unit 30. The operator may check the machine difference displayed on the output device 502, such as a display device.

### Summary

In conventional machine difference analysis, it is assumed that when the recipe setting values are the same, the sensor data behavior during processing is also the same. Based on this assumption, it is determined that there is a machine difference when the behavior of the sensor data during processing differed. However, even with the same recipe, the setting values are sometimes adjusted. As a result, conventional machine difference analysis often detects a difference in setting values as a machine difference and fails to analyze the true machine difference.

Furthermore, in conventional machine difference analysis, when machine differences for each step of a sensor 11, all steps of a sensor 11, all steps of a group of sensors 11, and all steps of the substrate processing apparatus 10 are to be calculated hierarchically, a separate model is required for each hierarchical level. Conventional machine difference analysis fails to compare machine differences within or across hierarchical levels, including machine differences for each step of a sensor 11, all steps of a sensor 11, all steps of a group of sensors 11, and all steps of the substrate processing apparatus 10.

Comparison of machine differences within hierarchical levels is, for example, comparison between the machine difference of “Sensor A1” and the machine difference of “Sensor B1,” both of which belong to the group of sensors 11. Comparison of machine differences across hierarchical levels is, for example, comparison between the machine difference of the substrate processing apparatus 10 and the machine difference of “Sensor A1.”

In the present embodiment, a single dimensionality reduction model 52 is trained using the reference dataset as a whole, and the machine difference at each hierarchical level is obtained by selecting the smallest unit reconstruction error range of the reconstruction error matrix 1000 illustrated in FIG. 6 and calculating the L2 norm. As a result, machine differences may be directly compared across or within hierarchical levels.

In this manner, in the present embodiment, machine difference analysis may be performed even on logs such as trace logs that include variations in setting values, thereby expanding the range of logs that allow for machine difference analysis. For example, variations in setting values refer to changes in setting values that do not affect the process. In the present embodiment, for example, in the machine difference analysis of logs with variations in setting values, when temperature is finely adjusted to optimize the process results, the difference in temperature is not analyzed as a machine difference.

Furthermore, in the present embodiment, since machine differences across or within hierarchical levels may be verified using a single dimensionality reduction model 50, machine differences ranging from the entirety to the details of the substrate processing apparatus 10 may be directly compared. In addition, as machine differences within or across hierarchical levels may be verified using a single dimensionality reduction model 50, calculation costs may be reduced.

As described above, in the present embodiment, the dimensionality reduction model 52 is trained using a reference dataset (reference normal data) of a reference substrate processing apparatus 10, and the trained dimensionality reduction model 50 is used to verify the reconstruction error of an analysis dataset (other data). In this case, the reconstruction error serves as an indicator for evaluating whether the other data is normal.

The reconstruction error is the difference between the original data and the reconstructed data. The reconstruction error of other data that has characteristics similar to the normal data tends to be relatively small. Meanwhile, the reconstruction error of abnormal data that includes machine differences or noise may be relatively large.

Accordingly, in the present embodiment, the dimensionality reduction model 52 is trained using a reference dataset of a reference substrate processing apparatus 10, and the trained dimensionality reduction model 50 is used to verify the reconstruction error of a verification dataset, which is then treated as a machine difference.

The substrate processing system 1 of the present embodiment may provide a technology that further improves the accuracy of machine difference analysis for a substrate processing apparatus 10.

The substrate processing apparatus 10 of the present disclosure is applicable to any type of apparatus, including an atomic layer deposition (ALD) apparatus, a capacitively coupled plasma (CCP) apparatus, an inductively coupled plasma (ICP) apparatus, a radial line slot antenna (RLSA) apparatus, an electron cyclotron resonance plasma (ECR) apparatus, and a helicon wave plasma (HWP) apparatus. The substrate processing apparatus 10 of the present disclosure is also applicable to a chemical vapor deposition (CVD) apparatus or an oxidation/annealing apparatus.

The substrate processing system 1 of the present disclosure is not limited to the configuration illustrated in FIG. 1, and various system configurations are possible depending on the application and purpose. The substrate processing apparatus 10 of the present disclosure is applicable to either a single-wafer apparatus that processes substrates one by one or a batch or semi-batch apparatus that processes a plurality of substrates simultaneously. The processes performed by the substrate processing apparatus 10 of the present disclosure include, for example, film formation and etching.

The present disclosure provides a technology that further improves the accuracy of machine difference analysis for a substrate processing apparatus.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An information processing apparatus comprising:
reconstruction error matrix generation circuitry configured to verify reconstruction errors of datasets of a plurality of substrate processing apparatuses using a dimensionality reduction model trained with a reference dataset and to generate reconstruction error matrices for the plurality of substrate processing apparatuses;
machine difference calculation circuitry configured to calculate a machine difference based on magnitudes of at least a portion of the reconstruction errors selected from a plurality of reconstruction errors included in the reconstruction error matrices; and
display control circuitry configured to cause the machine difference calculated by the machine difference calculation circuitry to be displayed on a display device.

2. The information processing apparatus of claim 1, wherein the reconstruction error matrix generation circuitry is further configured to verify a smallest unit reconstruction error and to generate the reconstruction error matrix for each of the plurality of substrate processing apparatuses, and
the machine difference calculation circuitry is further configured to calculate the machine difference for each hierarchical level based on a smallest unit reconstruction error range selected from a plurality of smallest unit reconstruction errors included in the reconstruction error matrices.

3. The information processing apparatus of claim 2, wherein the machine difference calculation circuitry is further configured to consider, as the smallest unit reconstruction error, the reconstruction error for each step of a sensor that detects a state of each of the plurality of substrate processing apparatuses and to calculate, as the machine difference for each hierarchical level, the magnitudes of the reconstruction errors for each step of the sensor, all steps of the sensor, all steps of a group of sensors, and all steps of the plurality of substrate processing apparatuses.

4. The information processing apparatus of claim 3, wherein the dataset includes setting values and log data of each sensor of at least one of the plurality of substrate processing apparatuses during substrate processing, the log data being associated with the setting values and stored for each executed substrate processing operation, and
the log data is configured to include changes in the setting values for each executed substrate processing operation.

5. The information processing apparatus of claim 1, wherein the machine difference calculation circuitry is further configured to calculate an L2 norm as the magnitude of the reconstruction error.

6. The information processing apparatus of claim 1, wherein the dimensionality reduction model is any one of principal component analysis (PCA), Gaussian process latent variable model (GPLVM), mixture probabilistic principal component analysis (MPPCA), kernel PCA, and probabilistic PCA.

7. A machine difference analysis method performed by an information processing apparatus that performs machine difference analysis on a plurality of substrate processing apparatuses, the method comprising:
verifying reconstruction errors of datasets of the plurality of substrate processing apparatuses using a dimensionality reduction model trained with a reference dataset and creating reconstruction error matrices for the plurality of substrate processing apparatuses;
calculating a machine difference based on magnitudes of at least a portion of the reconstruction errors selected from the reconstruction errors included in the reconstruction error matrices; and
displaying the calculated machine difference on a display device.

8. A substrate processing apparatus comprising the information processing apparatus of claim 1.
